(19) United States
(12) Patent Application Publication
(10) Pub. No.: US 2025/0199138 A1
(43) Pub. Date: Jun. 19, 2025

(54) LIDAR AND RECEIVER AND METHOD FOR RECEIVING DATA OF THE LIDAR, AND COMPUTER-READABLE MEDIUM

(71) Applicant: HESAI TECHNOLOGY CO., LTD., Shanghai (CN)

(72) Inventors: Shaoqing XIANG, Shanghai (CN); Zhao ZHAO, Shanghai (CN); Shiwei ZHENG, Shanghai (CN)

(73) Assignee: HESAI TECHNOLOGY CO., LTD., Shanghai (CN)

(21) Appl. No.: 19/066,851

(22) Filed: Feb. 28, 2025

Related U.S. Application Data
(63) Continuation of application No. PCT/CN2023/079434, filed on Mar. 3, 2023.

(30) Foreign Application Priority Data
Aug. 29, 2022 (CN) 202211041919.6

(51) Int. Cl. G01S 7/4863; G01S 7/4865; G01S 7/487; G01S 7/497

(52) U.S. Cl. CPC G01S 7/4863; G01S 7/4865; G01S 7/487; G01S 7/497

(57) ABSTRACT

This disclosure provides a LiDAR and a receiver and a method for receiving data of the LiDAR, and a computer-readable medium. A sampler of the receiver includes multiple sampling circuit groups corresponding to multiple sub-arrays of a photosensor array. When an echo spot falls on at least two sub-arrays, the sampler can sample electrical signals from the at least two sub-arrays by a sampling circuit group. A complete electrical signal from the echo spot can be sampled by a sampling circuit group. The integrity of an echo signal is ensured while the low power consumption of the LiDAR is maintained. The conflict between low power consumption of the LiDAR can be solved and integrity of an optical signal when alignment between an emitting end and a receiving end deviates.

This application is a bypass Continuation application of International Patent Application No. PCT/CN2023/079434, filed Mar. 3, 2023, which claims the benefit of priority under 37 C.F.R. 119 from Chinese Patent Application No. 202211041919.6, filed Aug. 29, 2022; the disclosures of all of which are incorporated herein by reference in their entirety.

### TECHNICAL FIELD

This disclosure relates to the technical field of LiDAR and, in particular, to a LiDAR and a receiver and a method for receiving data of the LiDAR, and a computer-readable medium.

### BACKGROUND

Light detection and ranging (LiDAR) is a sensor that emits detection light to an surrounding environment by a laser and receives echo light reflected back by an obstacle in the environment by a detector. Distance and position information of the obstacle can be determined based on a time delay between emitting the detection light and receiving the echo light. The detector is a photoelectric sensor. The echo light is converged on the photosensitive surface of the detector to form an echo spot. The detector converts a received optical signal into an electrical signal through photoelectric conversion. The LiDAR can sample and process the electrical signal to determine detection data of the obstacle.

In an application of LiDAR, multiple light emitter units in a transmitting part correspond one-to-one with multiple photosensitive pixels in a receiving part. One light emitter unit and one photosensitive pixel can form one detection channel. That is, when the light emitter unit in the detection channel emits the detection light, corresponding echo spot is converged on the photosensitive surface of the photosensitive pixel in the detection channel. When the photosensitive pixel performs photoelectric conversion, a sampling circuit coupled with the photosensitive pixel samples and outputs an echo electrical signal. Detection data is determined through further processing. However, during alignment of the LiDAR, the light emitter units and the photosensitive pixels are difficult to align and can probably deviate from a set position. In addition, even if the light emitter units and the photosensitive pixels are completely aligned during the alignment, disturbance such as heat or stress during operation of the LiDAR can also cause deviation in alignment of the light emitter units and the photosensitive pixels. If the positional correspondence between the light emitter units and the photosensitive pixels deviates, the echo spot corresponding to the detection light emitted by the light emitter unit can deviate from the photosensitive pixel of corresponding detection channel, potentially overlapping photosensitive pixels of two detection channels. In this case, if the sampling circuit of the detection channel is still used for data sampling, part of the echo signal can be lost, which can reduce the signal-to-noise ratio. To ensure the integrity of the echo signal, it is necessary to activate both sampling circuits corresponding to two photosensitive pixels covered by the echo spot simultaneously to sample electrical signals simultaneously in each detection channel during detection, in which can lead to excessive power consumption of the LiDAR.

### SUMMARY

A LiDAR, a receiver and a data receiving method of the LiDAR, and a computer-readable medium provided in this disclosure can solve the conflict between low power consumption and integrity of optical signal of the LiDAR when alignment between a transmitting part and a receiving part deviates.

In an aspect, this disclosure provides a receiver for a LiDAR, including: a photosensor array configured to receive an echo spot and convert an optical signal into an electrical signal, and a receiving circuit coupled with the photosensor array and configured to sample the electrical signal and output detection data, where the photosensor array includes multiple sub-arrays arranged along a first direction, and each of the multiple sub-arrays includes multiple photosensor units, and where the receiving circuit includes a sampler including multiple sampling circuit groups corresponding to the multiple sub-arrays, where when the echo spot falls on at least two sub-arrays, the sampler is configured to sample electrical signals from the at least two sub-arrays using a sampling circuit group.

In some embodiments of this disclosure, the receiving circuit further includes an activation module coupled with the photosensor array, including multiple activation circuits, and configured to activate a target photosensitive pixel to receive the echo spot and output the electrical signal.

In some embodiments of this disclosure, a target activation circuit is configured to activate the target photosensitive pixel, with the target photosensitive pixel corresponding to a distribution of the echo spot on the photosensor array, and where a target sampling circuit group is coupled with the target activation circuit and is configured to sample the electrical signal output by the target photosensitive pixel.

In some embodiments of this disclosure, each of the multiple sub-arrays includes multiple photosensor units arranged along the first direction and a second direction perpendicular to the first direction, and the receiving circuit further includes an activation module, the activation module includes first activation circuits corresponding one-to-one with photosensor units in the first direction and second activation circuits corresponding one-to-one with photosensor units in the second direction, and where the first activation circuits and the second activation circuits are configured to independently activate each of the multiple photosensor unit.

In some embodiments of this disclosure, the sampling circuit group includes multiple sampling circuits coupled one-to-one with first activation circuits of a sub-array, and where the multiple sampling circuits are coupled one-to-one with first activation circuits of an adjacent sub-array.

In some embodiments of this disclosure, the sampler further includes at least one selector, each of the multiple sampling circuits is coupled with a first activation circuit of corresponding sub-array and a first activation circuit of the adjacent sub-array by one selector, and where each selector is configured to control a corresponding sampling circuit to be electrically coupled with one first activation circuit.

In some embodiments of this disclosure, the second activation circuits are configured to sequentially activate photosensor units in different regions in a detection window to form a target photosensor unit group, with a position of the target photosensor unit group corresponding to a distribution of the echo spot on the target photosensitive pixel.

In some embodiments of this disclosure, the sampler further includes a shifter unit coupled with a sampling circuit and configured to couple the sampling circuit with at least one second activation circuit to form a sampling region, and the shifter unit is configured to move the sampling region along the second direction in the detection window.

In some embodiments of this disclosure, a moving frequency of the sampling region is consistent with a sampling frequency of the sampling circuit.

In some embodiments of this disclosure, a moving step length of the sampling region is less than a length of the sampling region in the second direction, with the sampling region partially overlapping in two adjacent sampling periods.

In another aspect, this disclosure provides a method for receiving data of a LiDAR, including: using a target photosensitive pixel in a photosensor array to receive an echo spot and convert an optical signal into an electrical signal, and using a receiving circuit to sample the electrical signal and output detection data, where the photosensor array includes multiple sub-arrays arranged along a first direction, each of the multiple sub-arrays includes multiple photosensor units, the receiving circuit includes a sampler, the sampler includes multiple sampling circuit groups corresponding one-to-one with the multiple sub-arrays, a correspondence between the target photosensitive pixel and a sub-array is determined based on a result of calibration, and where the using the receiving circuit to sample the electrical signal and output detection data includes: using a target sampling circuit group to sample the electrical signal output by the target photosensitive pixel and output the detection data.

In some embodiments of this disclosure, the receiving circuit further includes an activation module coupled with the photosensor array, the activation module includes multiple activation circuits, and where the using the receiving circuit to sample the electrical signal and output detection data further includes: using the activation module to activate the target photosensitive pixel to output the electrical signal.

In some embodiments of this disclosure, the using the activation module to activate the target photosensitive pixel includes: using first activation circuits and second activation circuits in the activation module to independently activate each photosensor unit in the target photosensitive pixel,
where each of the multiple sub-arrays includes multiple photosensor units arranged along the first direction and a second direction perpendicular to the first direction, the first activation circuits correspond to photosensor units in the first direction, and the second activation circuits correspond to photosensor units in the second direction.

In some embodiments of this disclosure, the sampling circuit group includes multiple sampling circuits corresponding one-to-one with first activation circuits of a sub-array, and the multiple sampling circuits are coupled one-to-one with first activation circuits of an adjacent sub-array, and where when the target photosensitive pixel includes photosensor units in a multiple sub-arrays, the using the target sampling circuit group to sample the electrical signal output by the target photosensitive pixel includes: using a target sampling circuit group corresponding to one of the multiple sub-arrays to sample the electrical signal output by the target photosensitive pixel, where at least one sampling circuit in the target sampling circuit group is configured to sample an electrical signal output by a photosensor unit of the target photosensitive pixel in the adjacent sub-array.

In some embodiments of this disclosure, the method further includes: using at least one selector to electrically couple the target sampling circuit group with first activation circuits of the target photosensitive pixel, where each sampling circuit in the target sampling circuit group is coupled with first activation circuits of two sub-arrays by a selector.

In some embodiments of this disclosure, the using the activation module to activate the target photosensitive pixel includes: using the second activation circuits to sequentially activate photosensor units in different regions in a detection window to form a target photosensor unit group, with a position of the target photosensor unit group corresponding to a distribution of the echo spot on the target photosensitive pixel.

In some embodiments of this disclosure, the using the target sampling circuit group to sample the electrical signal output by the target photosensitive pixel includes: using a shifter unit to couple the target sampling circuit group with at least one second activation circuit to form a sampling region, and controlling the shifter unit to move the sampling region along the second direction in the detection window, and controlling the target sampling circuit group to sample the electrical signal output by the target photosensitive pixel in moving sampling region.

In a third aspect, this disclosure further provides a LiDAR, including: at least one storage medium storing at least one instruction set for receiving data; and at least one processor in communication connection with the at least one storage medium, where when the LiDAR operates, the at least one processor is configured to read the at least one instruction set and implement the method for receiving data of any one of the embodiments in the second aspect.

In a fourth aspect, this disclosure further provides a non-transitory computer-readable medium storing at least one instruction set for receiving data, where when the at least one instruction set is executed by a processor, the processor is instructed to execute the method for receiving data in the second aspect.

It can be seen from the above technical solutions that in the receiver provided in this disclosure, a sampler includes multiple sampling circuit groups corresponding to multiple sub-arrays of a photosensor array. When an echo spot falls on at least two sub-arrays, the sampler can sample electrical signals from the at least two sub-arrays by a sampling circuit group. A complete electrical signal from the echo spot can be sampled using the sampling circuit group. The integrity of an echo signal can be ensured while the low power consumption of the LiDAR can be maintained. The conflict between low power consumption and integrity of optical signal of the LiDAR can be solved when alignment between a transmitting part and a receiving part deviates. The receiver for the LiDAR provided in this disclosure can lower the difficulty of alignment of the LiDAR. When the photosensor array deviates from a preset position after alignment or during operation of the LiDAR, the complete echo electrical signal of a detection channel can be sampled by the sampling circuit corresponding to a sub-array without realignment. The efficiency of the receiving circuit can be improved. The detection capability of the LiDAR can be improved while the low power consumption can be maintained.

In the method for receiving data of the LiDAR provided in this disclosure, the correspondence between the target photosensitive pixel and the sub-array is determined based on the result of calibration. The target photosensitive pixel can correspond with one sub-array or two sub-arrays. The correspondence depends on the position calibration result of the photosensor array. The target photosensitive pixel can correspond with a position of the echo spot of corresponding detection channel to receive a complete echo optical signal. Then the target sampling circuit group can be used to sample the electrical signal output by the target photosensitive pixel and output detection data. That is, regardless of whether the echo spot is converged on one sub-array or two sub-arrays, the target photosensitive pixel corresponding to the sub-array on which the echo spot is converged can be determined, ensuring that the complete echo spot can be received.

### BRIEF DESCRIPTION OF DRAWINGS

To more clearly illustrate the technical solutions in the embodiments of this disclosure, the accompanying drawings used in the embodiments will be briefly introduced below. The accompanying drawings in the description below merely illustrate some embodiments of this disclosure. Those of ordinary skill in the art can also derive other accompanying drawings from these accompanying drawings without creative efforts.

FIG. 1 shows a schematic structural diagram of a LiDAR 001, provided in some embodiments of this disclosure,

FIG. 2 shows a schematic structural diagram of a transmitter 20 and a receiver 40 of a LiDAR, provided in some embodiments of this disclosure,

FIG. 3 shows a schematic structural diagram of a receiver 400, provided in some embodiments of this disclosure,

FIG. 4 shows a schematic structural diagram of a receiver 400, provided in some embodiments of this disclosure,

FIG. 5 shows a schematic diagram of circuit principle of a receiver 400, provided in some embodiments of this disclosure,

FIG. 6 shows a schematic diagram of principle of an off-axis LiDAR, provided in some embodiments of this disclosure,

FIG. 7 shows a schematic diagram of a target photosensitive pixel, provided in some embodiments of this disclosure,

FIG. 8 shows a schematic diagram of coupling between a shifter unit 422-5 and a sampling circuit, provided in some embodiments of this disclosure,

FIG. 9 shows a schematic diagram of moving of a sampling region along a second direction, provided in some embodiments of this disclosure,

FIG. 10 shows a flowchart of a method P100 for receiving data of a LiDAR, provided in some embodiments of this disclosure, and

FIG. 11 shows a hardware structure diagram of a control device 600, provided in some embodiments of this disclosure.

### DESCRIPTION OF EMBODIMENTS

The following description provides specific application scenarios and requirements of this disclosure to enable those skilled in the art to create and use the content in this disclosure. Various partial modifications to the disclosed embodiments are apparent to those skilled in the art, and the general principles defined herein can be applied to other embodiments and applications without departing from the spirit and scope of this disclosure. Accordingly, this disclosure is not limited to the shown embodiments and falls within the widest scope consistent with that of the claims.

The terms used herein are only used to describe specific exemplary embodiments and are not restrictive. For example, singular forms “a/an,” “one,” and “the” used here can also include plural forms, unless otherwise explicitly stated in the context. When used in this disclosure, at least one of the term “comprise,” “include,” or “contain” means the presence of at least one of associated integers, steps, operations, elements, or components, but do not exclude the presence of at least one of one or more other features, integers, steps, operations, elements, components, or groups, or the addition of at least one of other features, integers, steps, operations, elements, components, or groups in the system/method.

Considering the following description, these and other features of this disclosure, operations and functions of related elements of the structure, and the combination and manufacturing economy of the components can be significantly improved. Referring to the accompanying drawings, all of which form a part of this disclosure. However, it should be clearly understood that the accompanying drawings are merely for illustrative and descriptive purposes and are not intended to limit the scope of this disclosure. It should also be understood that the accompanying drawings are not drawn to scale.

The flowchart used in this disclosure shows the operations implemented by the system based on some embodiments in this disclosure. It should be clearly understood that the operations in the flowchart can be implemented out of sequence. Rather, the operations can be implemented in reverse order or simultaneously. In addition, one or more other operations can be added to the flowchart. One or more operations can be removed from the flowchart.

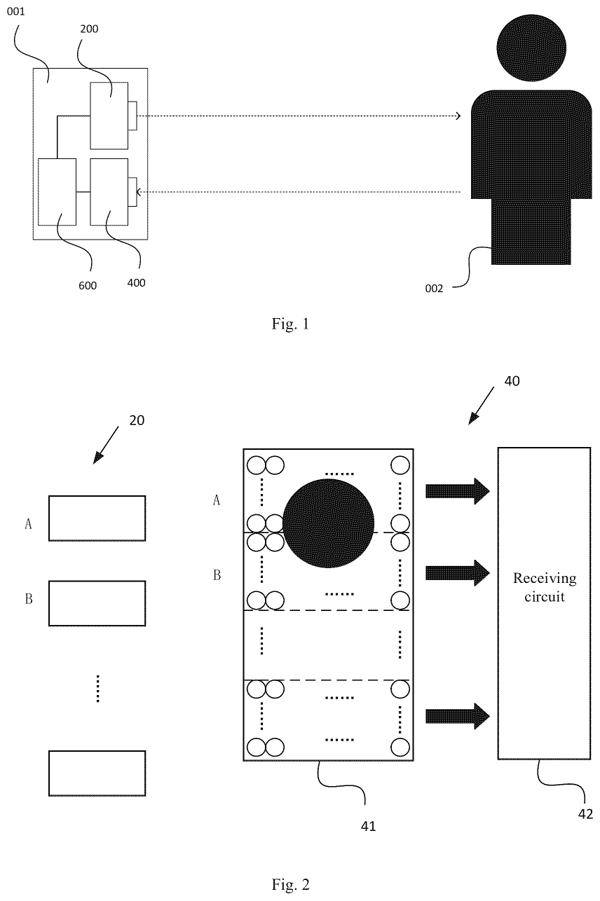

FIG. 1 shows a schematic structural diagram of a LiDAR 001, provided in some embodiments of this disclosure. The LiDAR 001 is a radar system that emits detection light (a laser beam) to detect a position, a velocity, and other characteristic parameters of an object 002. Working principle of the LiDAR involves emitting the detection light to a surrounding environment, then receiving an echo optical signal reflected from an object, and converting into an echo electrical signal. After appropriate processing, detection information of the object, such as a distance, an orientation, a velocity, and other parameters of the object relative to the LiDAR 001, can be determined. When operating, the LiDAR 001 can emit detection light at different azimuth angles within a field-of-view angle range and receive echo light reflected back from an object at corresponding azimuth angle to determine the detection information of the object at the azimuth angle. A frame of point cloud data is generated based on detection data at the various azimuth angles within the field-of-view angle range.

As shown in FIG. 1, the LiDAR 001 can include a transmitter 200, a receiver 400, and a controller 600. The transmitter 200 can emit a laser beam outward based on a preset time sequence when operating. The receiver 400 can receive an echo optical signal reflected back from an object, perform photoelectric conversion and output an echo electrical signal to determine detection data. The controller 600 can control the transmitter 200 and the receiver 400, and process the detection data to determine detection information such as a distance and an orientation of the object.

FIG. 2 shows a schematic structural diagram of a transmitter 20 and a receiver 40 of a LiDAR. The receiver 40 can include a photosensor array 41 and a receiving circuit 42.

The photosensor array 41 can include multiple sub-arrays arranged along a first direction. Each sub-array can form a photosensitive pixel. For example, the first direction can be a vertical direction (e.g., when an optical axis of the LiDAR 001 is located in a horizontal plane, the first direction is a direction perpendicular to the horizontal plane). For example, the sub-array can be an avalanche photodiode (“APD”) array, a single photon avalanche diode (“SPAD”) array, a silicon photomultiplier tube (“SiPM”) array, or the like. Each sub-array can include multiple photosensor units. Multiple hollow small circles in FIG. 2 represent multiple photosensor units. The photosensor unit can be an SPAD. The receiving circuit 42 is coupled with the photosensor array 41, and can sample an electrical signal output by the photosensor array 41 and output detection data. The receiving circuit 42 includes multiple sampling circuits (not shown in the figure). The multiple sampling circuits correspond one-to-one with the sub-arrays to sample echo electrical signals output by the sub-arrays.

As shown in FIG. 2, the LiDAR further includes the transmitter 20. The transmitter includes an emitter array. A light emitter unit can emit a detection light beam. The light emitter unit can include one or more vertical-cavity surface-emitting laser (“VCSEL”), edge emitting lasers (“EELs”), or other laser emitters.

It can be understood by those skilled in the art that the transmitter 20 and the receiver 40 of the LiDAR can further include other components, such as lenses or lens groups (not shown in the figure).

As mentioned above, the emitter array and the photosensor array of the LiDAR have a field-of-view correspondence, which can form multiple detection channels. As shown in FIG. 2, a light emitter unit A emits detection light at a preset azimuth angle. Echo light reflected from an object at the azimuth angle is converged on a photosensitive surface of a photosensor sub-array A. The photosensor sub-array A performs photoelectric conversion on an echo optical signal and outputs. That is, the light emitter unit A and the photosensor sub-array A form a detection channel A. It can be understood that other light emitter units in the emitter array can correspond one-to-one with other photosensor sub-arrays in the photosensor array and form detection channels respectively.

However, the light emitter unit and the photosensor sub-array are very small. The emitter array and the photosensor array are difficult to align. Relative positions of the emitter array and the photosensor array shown in FIG. 2 can deviate from a preset alignment. If a positional correspondence between the light emitter units and the photosensitive pixels deviates, an echo spot corresponding to detection light emitted by a light emitter unit can deviate from the photosensor sub-array of corresponding detection channel, potentially overlapping photosensor sub-arrays of two detection channels. In the case of FIG. 2, the photosensor array deviates upward relative to the emitter array. When the light emitter unit A of the detection channel A emits the detection light, the echo light reflected by the object is converged and forms an echo spot (as shown by a black solid circle in FIG. 2) that falls on the photosensor sub-array A of the detection channel A and a photosensor sub-array B of an adjacent detection channel. Correspondingly, when the light emitter unit B emits a detection light, an echo spot received from reflection by an object will fall on the photosensor sub-array B and a photosensor sub-array below it. Echo spot of each detection channel will deviate relative to a preset position.

In the case where the light spot deviates from the photosensor sub-array of corresponding channel due to the deviation in the positional correspondence between the emitter array and the photosensor array, if the receiving circuit 42 still samples an electrical signal of the sub-array A, an echo signal distributed on the sub-array B can be lost. As a result, the echo signal is lost, the signal-to-noise ratio is reduced, and the detection capability of the LiDAR is affected. To ensure the integrity of the echo signal, in the prior art, a sampling circuit corresponding to the sub-array A and a sampling circuit corresponding to the sub-array B in the receiving circuit 42 can be turned on simultaneously to sample the electrical signal of the sub-array A and an electrical signal of the sub-array B. However, the echo spot of each detection channel will deviate and cover two adjacent sub-arrays. Sampling circuits of two detection channels need to work simultaneously in detection of each detection channel, resulting in excessive power consumption of the LiDAR.

It should be noted that the case of FIG. 2 is that the photosensor array deviates upward relative to the emitter array. In a practical situation, the photosensor array can deviate in other directions relative to the emitter array, which is not limited in this disclosure.

Embodiments of this disclosure provide a receiver for a LiDAR. The receiver includes a photosensor array and a receiving circuit. The photosensor array can receive an echo spot and convert an optical signal into an electrical signal. The receiving circuit is coupled with the photosensor array and can sample the electrical signal and output detection data. The photosensor array includes multiple sub-arrays arranged along a first direction. Each of the multiple sub-arrays includes multiple photosensor units. The receiving circuit includes a sampler. The sampler includes multiple sampling circuit groups corresponding to the multiple sub-arrays. When the echo spot falls on at least two sub-arrays, the sampler can sample electrical signals from the at least two sub-arrays using a sampling circuit group.

In the receiver for the LiDAR provided in the embodiments of this disclosure, the sampler includes multiple sampling circuit groups corresponding to multiple sub-arrays of the photosensor array. When an echo spot falls on at least two sub-arrays, the sampler can sample electrical signals from the at least two sub-arrays using the sampling circuit group. That is, a complete electrical signal from the echo spot can be sampled using the sampling circuit group. The integrity of an echo signal can be ensured while the low power consumption of the LiDAR can be maintained. The conflict between low power consumption and integrity of optical signal of the LiDAR can be solved when alignment between a transmitting part and a receiving part deviates. The receiver of the LiDAR provided in this disclosure can lower the difficulty of alignment of the LiDAR. When the photosensor array deviates from a preset position after alignment or during operation of the LiDAR, the complete echo electrical signal one of a detection channel can be sampled by the sampling circuit corresponding to a sub-array without realignment. The efficiency of the receiving circuit can be improved. The detection capability of the LiDAR can be improved while the low power consumption can be maintained.

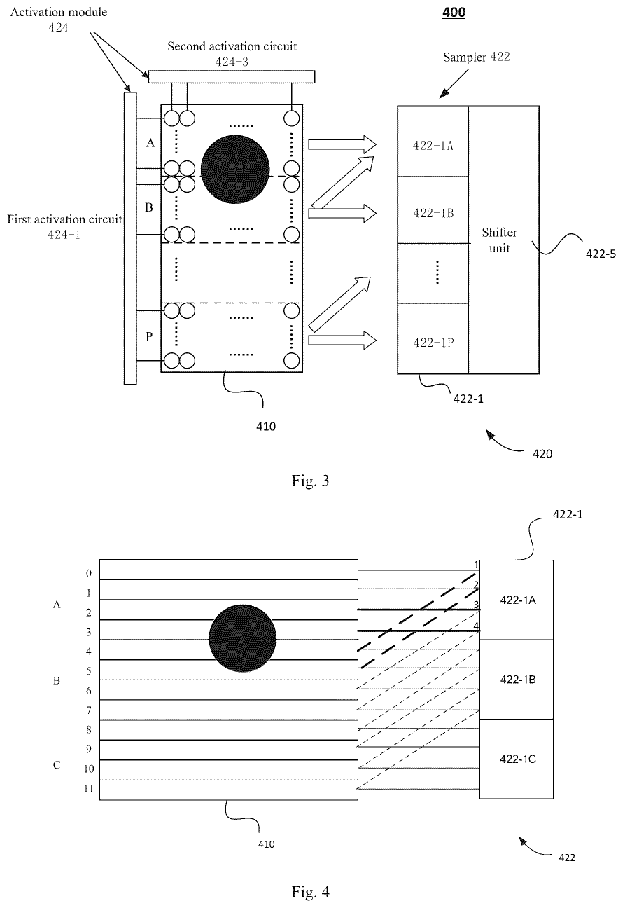

FIG. 3 shows a schematic structural diagram of a receiver 400, provided in some embodiments of this disclosure. The receiver 400 includes a photosensor array 410 and a receiving circuit 420.

The structure of the photosensor array 410 can refer to the description of the photosensor array 41.

The receiving circuit 420 includes a sampler 422. The sampler 422 includes multiple sampling circuit groups 422-1 corresponding to multiple sub-arrays. The number of the sampling circuit groups 422-1 is the same as the number of the sub-arrays of the photosensor array 410 and there is a preset correspondence. For example, in FIG. 3, the photosensor array 410 includes sub-arrays A B . . . P, where P is a positive integer greater than 1. The sampler 422 correspondingly includes sampling circuit groups 422-1A, 422-1B, . . . , and 422-1P.

In the embodiments of this disclosure, when an echo spot falls on at least two sub-arrays, the sampler can sample electrical signals from the at least two sub-arrays using a sampling circuit group.

In an embodiment, when an echo spot falls on at least two sub-arrays, the sampler 422 can sample electrical signals from the at least two sub-arrays using a sampling circuit group 422-1. As shown in FIG. 3, when an echo spot of a detection channel A corresponding to the sub-array A (as shown by a black solid circle in FIG. 3) falls on photosensitive surfaces of the sub-array A and the sub-array B, the sampling circuit group 422-1A corresponding to the sub-array A can sample an electrical signal of the sub-array A and an electrical signal (as shown by a hollow arrow in FIG. 3) of the sub-array B. Sampling of complete echo information by the sampling circuit group 422-1A can be achieved.

It can be seen that in the receiver 400 provided in this disclosure, if deviation of the light spot causes the echo spot to deviate from the sub-array of corresponding detection channel, the receiving circuit 420 can activate one sampling circuit group to sample the electrical signal from one or more sub-arrays covered by the echo spot. That is, the complete electrical signal from the echo spot can be sampled without simultaneously activating sampling circuit groups corresponding to two sub-arrays. The sampling circuit group of a detection channel needs to work in the detection of a detection channel. The power consumption of the LiDAR can be reduced while the integrity of the echo signal can be ensured. The conflict between low power consumption and integrity of optical signal of the LiDAR can be solved when alignment between a transmitting part and a receiving part deviates. The receiver for the LiDAR provided in the embodiments of this disclosure can lower the difficulty of alignment of the LiDAR. When the photosensor array deviates from a preset position after alignment or during operation of the LiDAR, the complete echo electrical signal from a detection channel can be sampled by the sampling circuit corresponding to a sub-array without realignment. The efficiency of the receiving circuit can be improved. The detection capability of the LiDAR can be improved while the low power consumption can be maintained.

It should be noted that a corresponding relationship between the sampling circuit group and the sub-array is not limited to the example in FIG. 3, as long as it can be realized that the electrical signal from one or more sub-arrays on which the echo spot is distributed can be sampled using a sampling circuit group 422-1. In some embodiments, the sampling circuit group 422-1B corresponding to the sub-array B can also sample the electrical signal of the sub-array A. When the echo spot of the detection channel A corresponding to the sub-array A (as shown by the black solid circle in FIG. 3) falls on the photosensitive surface of the sub-array B or the photosensitive surfaces of the sub-array A and the sub-array B, the electrical signal from one or more sub-arrays corresponding to the echo spot can be sampled by the sampling circuit group 422-1B of the detection channel to determine complete echo information.

In some embodiments, the receiving circuit can further include an activation module. to the activation module is coupled with the photosensor array. For example, the activation module includes multiple activation circuits. The activation module can activate a target photosensitive pixel. The photosensitive pixel can receive the echo spot and output the electrical signal.

For example, the target photosensitive pixel includes a photosensor unit array for receiving the echo spot. Target photosensitive pixels correspond one-to-one with detection channels. Each target photosensitive pixel can perform photoelectric conversion on the optical signal of the echo spot of corresponding detection channel and output an electrical signal for determining detection information of the detection channel. In some embodiments, the target photosensitive pixels can correspond one-to-one with the sub-arrays in the photosensor array. That is, each sub-array can be a target photosensitive pixel. There can be other correspondences. For example, some sub-arrays and some adjacent sub-arrays form a target photosensitive pixel.

In some embodiments, as shown in FIG. 3, the activation module 424 can activate the target photosensitive pixel using a target activation circuit, with the target photosensitive pixel corresponds to a distribution of the echo spot on the photosensor array 410.

The target photosensitive pixel corresponds to the distribution of the echo spot on the photosensor array. A sub-array or some sub-arrays corresponding to the echo spot can form the target photosensitive pixel to receive a complete echo optical signal. In addition, some sub-arrays that will not be covered by the echo spot, even in the preset corresponding detection channel, are not used to form the target photosensitive pixel, and are not activated to receive the optical signal. Reception of noise can be reduced and the signal-to-noise ratio of detection can be improved while the integrity of the echo optical signal can be ensured.

In an embodiment, each sub-array includes N rows of photosensor units, where Nis a positive integer greater than 1. If the emitter array and the photosensor array are aligned strictly based on a preset relationship, that is, the echo spot of the detection channel A falls on the photosensitive surface of the sub-array A, the target activation circuit can activate the sub-array A as the target photosensitive pixel. Correspondingly, each sub-array can be the target photosensitive pixel for corresponding detection channel. If the emitter array and the photosensor array deviate from the preset relationship, for example, the echo spot falls on the photosensitive surface of the sub-array B or the photosensitive surfaces of the sub-array A and the sub-array B, the target activation circuit can activate a target photosensitive pixel including photosensor units covered by the echo spot. For example, if the photosensor array deviates upward relative to the emitter array, the echo spot of each detection channel deviates downward by a distance of two rows of photosensor units relative to the preset corresponding sub-array of the channel. Photosensor units from the third row to the N^{th} row of the sub-array corresponding to each detection channel and photosensor units in the first and second rows in the adjacent sub-array below can together form the target photosensitive pixel to receive and perform photoelectric conversion on the echo spot of corresponding detection channel. As shown in FIG. 3, photosensor units from the third row to the N^{th} row of the sub-array A and photosensor units in the first and second rows of the sub-array B form the target photosensitive pixel for the channel A. The settings for other detection channels can be changed in sequence. In such a case, the target photosensitive pixel can correspond to the distribution of the echo spot on the photosensor array. The complete echo optical signal can be received. The noise can be reduced, and the signal-to-noise ratio can be improved.

In some embodiments, each sub-array of the photosensor array can include multiple photosensor units arranged along a first direction and a second direction. The second direction is perpendicular to the first direction. A first direction in which the photosensor units are arranged can be consistent with a first direction in which the sub-arrays are arranged. For example, the first direction is vertical direction. In this case, the second direction is a horizontal direction. It can also be represented that each sub-array includes multiple rows and columns of photosensor units.

Correspondingly, the activation module can include first activation circuits correspond one-to-one with photosensor units in the first direction and second activation circuits correspond one-to-one with photosensor units in the second direction. The first activation circuit and the second activation circuit can independently activate each photosensor unit. For example, as shown in FIG. 3, a first activation circuit can be a row activation circuit. Each first activation circuit 424-1 is coupled each row of photosensor units arranged in the vertical direction. A second activation circuit is a column activation circuit. Each second activation circuit 424-3 is coupled with each column of photosensor units arranged in the horizontal direction. In such a case, each photosensor unit is coupled with a first activation circuit and a second activation circuit. The first activation circuits and the second activation circuits can independently activate each photosensor unit.

For example, first activation circuits and second activation circuits can activate multiple photosensor units to form the target photosensitive pixel. The target photosensitive pixel corresponds to the distribution of the echo spot on the photosensor array, which can improve the signal-to-noise ratio of detection of the LiDAR.

In some embodiments, the sampling circuit group includes multiple sampling circuits. The multiple sampling circuits can be coupled one-to-one with first activation circuits of a sub-array. The multiple sampling circuits can be coupled one-to-one with first activation circuits of an adjacent sub-array. That is, each sampling circuit can be coupled with first activation circuits of at least two adjacent sub-arrays. Each sampling circuit group can sample electrical signals from at least two sub-arrays. In some embodiments, each sampling circuit in a sampling circuit group can sample an electrical signal from a sub-array corresponding to the sampling circuit group, or an electrical signal from a sub-array adjacent to the sub-array.

FIG. 4 shows a schematic structural diagram of a receiver 400, provided in some embodiments of this disclosure. FIG. 4 shows three sub-arrays A, B, and C of a photosensor array 410. Each sub-array includes four rows of photosensor units as an example. The sub-array A includes photosensor units from the zeroth row to the third row. The sub-array B includes photosensor units from the fourth row to the seventh row. The sub-array C includes photosensor units from the eighth row to the eleventh row. Correspondingly, the sampler 422 includes three sampling circuit groups 422-1. The sub-array A corresponds to the sampling circuit group 422-1A. The sub-array B corresponds to the sampling circuit group 422-1B. The sub-array C corresponds to the sampling circuit group 422-1C. Each sampling circuit group 422-1 includes four sampling circuits. For example, the sampling circuit group 422-1A includes four sampling circuits numbered 1, 2, 3, and 4, respectively.

For example, each sampling circuit in the sampling circuit group is coupled one-to-one with the first activation circuits of the corresponding sub-array. Each sampling circuit is also coupled with a first activation circuit of at least one adjacent sub-array. The multiple sampling circuits in each sampling circuit group are also coupled one-to-one with multiple first activation circuits of at least one adjacent sub-array. In the example of FIG. 4, a solid line represents the coupling between each sampling circuit and a first activation circuit of photosensor units in a row in the corresponding sub-array. A dashed line represents the coupling between each sampling circuit and a first activation circuit photosensor units in a row in the adjacent sub-array.

Taking the sampling circuit group 422-1A as an example, a first sampling circuit of the sampling circuit group 422-1A is coupled with a first activation circuit of photosensor units in the zeroth row of the sub-array A and a first activation circuit of photosensor units in the fourth row of the sub-array B. Similarly, a second sampling circuit of the sampling circuit group 422-1A is coupled with a first activation circuit of photosensor units in the first row of the sub-array A and a first activation circuit of photosensor units in the fifth row of the sub-array B. A third sampling circuit of the sampling circuit group 422-1A is coupled with a first activation circuit of photosensor units in the second row of the sub-array A and a first activation circuit of photosensor units in the sixth row of the sub-array B. A fourth sampling circuit of the sampling circuit group 422-1A is correspondingly coupled with a first activation circuit of photosensor units in the third row of the sub-array A and a first activation circuit of photosensor units in the seventh row of the sub-array B. The coupling relationship between the sampling circuit group 422-1B and the sampling circuit group 422-1C is similar to that of the sampling circuit group 422-1A.

Through the coupling method of the sampler 422 in FIG. 4, a complete echo signal can be sampled under low power consumption even when the emitter array and the photosensor array deviate relative to a preset alignment. For example, in FIG. 4, an echo spot of a detection channel deviates downward relative to the preset corresponding sub-array by two rows. The echo spot of each detection channel can fall on photosensor units in two sub-arrays. For example, the echo spot of the detection channel A falls on photosensor units in the second row and the third row of the sub-array A and photosensor units in the fourth row and the fifth row of the sub-array B. In this case, when the detection channel A is detecting, photosensor units in the zeroth row and the first row of the sub-array A cannot receive the echo signal. Photosensor units in the second row and the third row can receive a part of the echo signal. The other part of the echo signal can be received by photosensor units in the fourth row and the fifth row of the sub-array B. In this case, for the detection channel A, the LiDAR 001 can control the first activation circuits 424-1 corresponding to the photosensor units in the second row and the third row of the sub-array A to activate the photosensor units in the second row and the third row. The LiDAR can control the first activation circuits 424-1 corresponding to the photosensor units in the fourth row and the fifth row of the sub-array B to activate the photosensor units in the fourth row and the fifth row of the sub-array B. The target photosensitive pixel of the detection channel A can be formed. In this way, the LiDAR 001 can activate photosensor units corresponding in position to the echo spot on the photosensor array to form the target photosensitive pixel. The power consumption of the LiDAR can be reduced. The complete echo signal can be received. The signal-to-noise ratio of detection of the LiDAR can be improved.

Through the coupling method in the embodiments of this disclosure, each sampling circuit can sample electrical signals from two adjacent sub-arrays. Even if the echo spot falls on two adjacent sub-arrays or the sub-array corresponding to another detection channel, the complete electrical signal of the echo spot can be sampled by sampling circuits in a sampling circuit group. As shown in FIG. 4, the echo spot of the detection channel A is distributed on the photosensor units from the second row to the fifth row (covers the sub-array A and the sub-array B) of the photosensor array 410. The echo signal of the detection channel can still be sampled using the sampling circuit group 422-1 A corresponding to the detection channel A. For example, the sampling circuit group 422-1A includes the first to the fourth sampling circuits. The first sampling circuit is coupled with the photosensor units in the zeroth row and the fourth row. to the first sampling circuit can sample the electrical signal of photosensor units in the fourth row. The second sampling circuit is coupled the photosensor units in the second row and the fifth row. to the second sampling circuit can sample the electrical signal of photosensor units in the fifth row. The third sampling circuit and the fourth sampling circuit can sample the electrical signals of photosensor units in the third row and the fourth row respectively (as shown by two bold solid lines and two bold dashed lines in FIG. 4). Even if the emitter array and the photosensor array deviate relative to the preset alignment, causing the echo spot of each detection channel to deviate from the preset corresponding photosensitive sub-array, a sampling circuit group can still be used to receive the complete echo signal by the technical solutions in the embodiments of this disclosure. The efficiency of the receiving circuit can be improved. The power consumption of the LiDAR can be reduced.

It should be noted that in the example of FIG. 4, the first activation circuits corresponding to each row of photosensor units of the sub-array B are coupled one-to-one with the sampling circuits in the sampling circuit group 422-1A in addition to the sampling circuits in the sampling circuit group 422-1B. The first activation circuits corresponding to each row of photosensor units of the sub-array C are coupled one-to-one with the sampling circuits in the sampling circuit group 422-1B in addition to the sampling circuits in the sampling circuit group 422-1C. Each row of photosensor units of the sub-array has a data flow mapping relationship with two sampling circuits. A data flow output by each row of photosensor units of the sub-array B can be output to both the sampling circuit group 422-1A and the sampling circuit group 422-1B. A data flow output by each row of photosensor units of the sub-array C can be output to both the sampling circuit group 422-1B and the sampling circuit group 422-1C. However, this disclosure is not limited to the above mapping relationship. The sampling circuits and each row of photosensor units or the first activation circuits may not have a one-to-one correspondence.

In some embodiments, M rows of photosensor units of each sub-array can be a group. M is a positive integer greater than 1. For example, M=2, M=3, or the like. Each sampling circuit can correspond to a group of photosensor units. Each sampling circuit can be coupled with M first activation circuits 424-1 of M rows of photosensor units of the corresponding sub-array and M first activation circuits 424-1 of M rows of photosensor units of at least one adjacent sub-array. M is set to a positive integer greater than 1. A sampling circuit corresponds to multiple first activation circuits. The number of sampling circuits can be reduced. Cross wiring between the photosensor array and the receiving circuit can be reduced. The wiring complexity of the receiving circuit can be reduced.

It should also be noted that relative positions (e.g., number of rows) of two rows or groups of photosensor units corresponding to each sampling circuit of respective sub-arrays can be same or different. For example, in FIG. 4, two rows of photosensor units corresponding to the first sampling circuit of the sampling circuit group 422-1A include a first row of photosensor units of the sub-array A and a first row of photosensor units of the sub-array B. In other examples, two rows or groups of photosensor units corresponding to the first sampling circuit can include a first row of photosensor units of the sub-array A and/or the second or another row of photosensor units of the sub-array B.

In some embodiments, the sampler can further include at least one selector. Each sampling circuit can be coupled with the first activation circuit of the corresponding sub-array and the first activation circuit of the adjacent sub-array by a selector.

In an embodiment, each sampling circuit can be coupled with two first activation circuits of two adjacent sub-arrays by a selector. Or each sampling circuit can be coupled with two groups of first activation circuits of two adjacent sub-arrays by a selector. Each selector can control a corresponding sampling circuit to be electrically coupled with a first activation circuit or a group of first activation circuits. It can be understood that although each sampling circuit is coupled with two or more first activation circuits or two or more groups of first activation circuits with a data flow mapping relationship, each sampling circuit can be electrically coupled with a first activation circuit or a group of first activation circuits by the selector. That is, during detection, each sampling circuit samples or receives electrical signals from a first activation circuit or a group of first activation circuits.

For example, when a detection channel is detecting, each of multiple sampling circuits in the sampling circuit group corresponding to the detection channel is coupled with at least two first activation circuits or two groups of first activation circuits. Photosensor units corresponding to the at least two first activation circuits or two groups of first activation circuits do not simultaneously receive the echo signal of the detection channel. For example, photosensor units corresponding to a first activation circuit or a group of first activation circuits can receive the echo signal. Photosensor units corresponding to other first activation circuits are not covered by the echo spot. The sampling circuit is controlled by the selector to be electrically coupled with a first activation circuit or a group of first activation circuits. Targeted sampling can be performed on the echo signal to reduce the sampling of invalid signals, which can improve the efficiency of the receiving circuit, and reduce the power consumption.

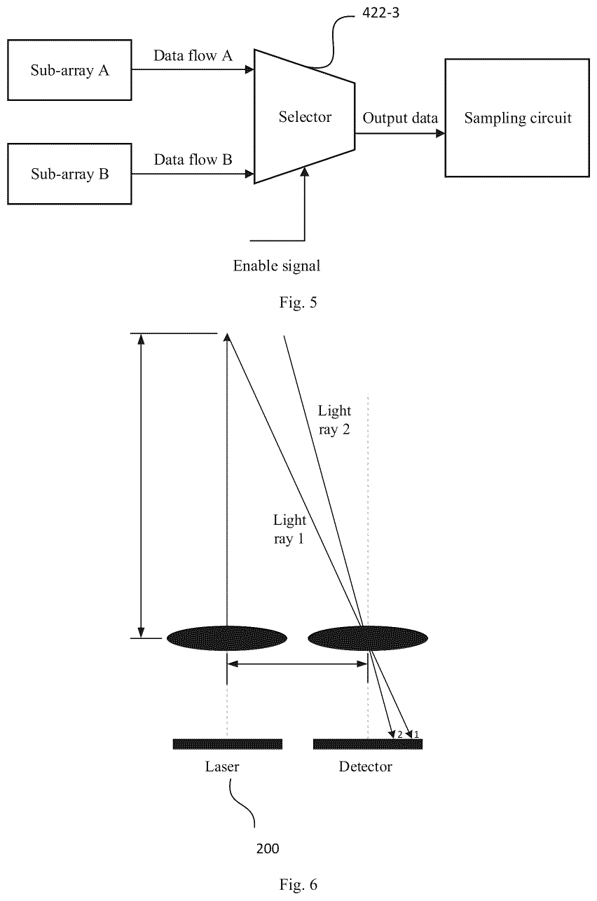

FIG. 5 shows a schematic diagram of circuit principle of a receiver 400, provided in some embodiments of this disclosure. As shown in FIG. 5, a row or a group of photosensor units of sub-array A and a row or a group of photosensor units of adjacent sub-array B are correspondingly coupled with the same sampling circuit by a selector 422-3. The sub-array A can output a data flow A in the form of an electrical signal. The selector 422-3 can output the data flow A to the sampling circuit. The sampling circuit can sample data of the sub-array A. The sub-array B can output a data flow B in the form of an electrical signal. The selector 422-3 can output the data flow B to the sampling circuit. The sampling circuit can sample data of the sub-array B. That is, the sampling circuit can be controlled by the selector 422-3 to sample electrical signals of the sub-array A and the sub-array B. To reduce the sampling of invalid signals, a sampling position of the sampling circuit can be determined by selecting an enable signal for the selector. The sampling circuit is electrically coupled with the first activation circuit of the sub-array A to sample the electrical signal of the sub-array A or is electrically coupled with the first activation circuit of the sub-array B to sample the electrical signal of the sub-array B.

In an embodiment, sampling circuits correspond one-to-one with selectors. Each sampling circuit is coupled with at least a first activation circuit of the corresponding sub-array and a first activation circuit of the adjacent sub-array. Selectors corresponding one-to-one with the sampling circuits can control each sampling circuit to be electrically coupled with which one first activation circuit or group of first activation circuits to sample electrical signals output by the first activation circuit or the first activation circuits.

It should be noted that the principle of this disclosure is explained with an example of a linear photosensor array formed by the photosensor sub-arrays arranged along the first direction in the above embodiments. In practical applications, the photosensor array can further include multiple photosensor sub-arrays arranged along the second direction. For example, the photosensor array includes sub-arrays arranged in a two-dimensional form or other forms, which is not limited in this disclosure.

In some embodiments, an activation module further includes a second activation circuit. In some examples, the second activation circuit can sequentially activate photosensor units in different regions in a detection window to form a target photosensor unit group, with a position of the target photosensor unit group corresponding to a distribution of an echo spot on a target photosensitive pixel.

In an off-axis LiDAR (a transmitter and a receiver include different lenses or lens groups), as the distance between the LiDAR and the object increases, the echo spot will move from the receiver to the transmitter in the horizontal direction of the photosensor array. Within a period of time, the echo spot of each detection channel is focused on a local region of the corresponding target photosensitive pixel.

FIG. 6 shows a schematic diagram of principle of an off-axis LiDAR, provided in some embodiments of this disclosure. The laser beam emitted by the laser of the transmitter 200 is projected to the object (not shown in FIG. 6) through the lens (group). The echo light reflected by the object is focused on the detector through the lens (group) of the receiver. As the distance between the object and the LiDAR increases, the echo light changes from the light ray 1 to the light ray 2, and the echo spot moves from the position 1 of the detector to the position 2.

Based on the embodiments of this disclosure, the second activation circuit is used to sequentially activate photosensor units in different regions in the detection window to form a target photosensor unit group. The position of the target photosensor unit group corresponds to the distribution of the echo spot on the target photosensitive pixel. The detection window refers to a time window during which a detection channel emits detection light, the target photosensitive pixel begins to receive the echo signal, and the echo signal from corresponding farthest target distance returns to the LiDAR and the detection ends. That is, corresponding to a beam of detection light, the detection window refers to a time period from a time point when the target photosensitive pixel begins to receive the echo signal corresponding to the detection light to a time point when the reception of the echo signal corresponding to the detection light ends. Based on the above analysis, the echo spot moves along the second direction of the target photosensitive pixel in the detection window. Through the position of the target photosensor unit group corresponding to the distribution of the echo spot on the target photosensitive pixel, the target photosensor unit group corresponding to the echo spot can receive the echo signal. Photosensor units not covered by the echo spot can be in a non-activated or non-gated state. In such a case, the power consumption of the LiDAR can be reduced. Receiving too many interference signals such as ambient light can be avoided. The signal-to-noise ratio of detection can be improved.

For example, the second direction is consistent with the relative positions of the transmitter and the receiver. When the transmitter and the receiver are relatively arranged in the horizontal direction, the second direction is the horizontal direction.

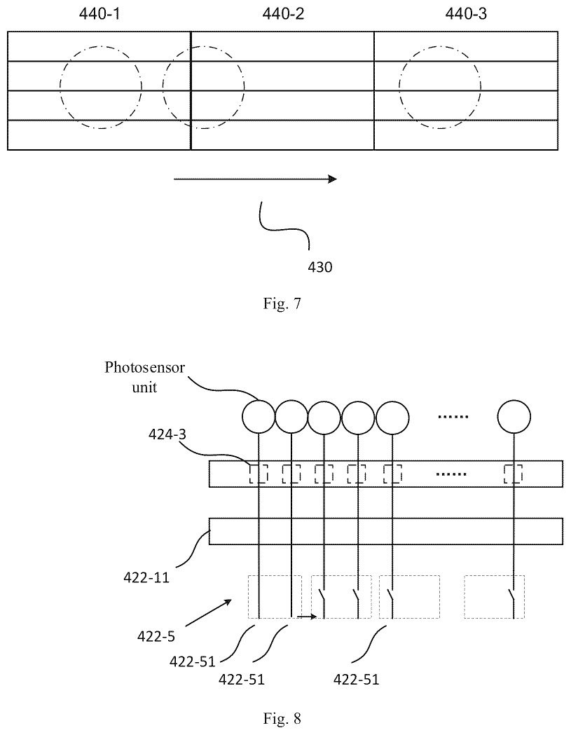

FIG. 7 shows a schematic diagram of a target photosensitive pixel, provided in some embodiments of this disclosure. As shown in FIG. 7, the photosensor array 430 includes three regions along the second direction that are a first region 440-1, a second region 440-2, and a third region 440-3. Each region includes a number of photosensor units along the second direction. For example, a width of each region in the second direction can be greater than or equal to a diameter of the echo spot.

A dashed circle in FIG. 7 represents the echo spot. FIG. 7 shows that as the distance between the object and the LiDAR increases, the echo spot moves horizontally to the right on the target photosensitive pixel. For example, the second activation circuit 424-3 can sequentially activate photosensor units from the first region 440-1 to the third region 440-3 to form a target photosensor unit group. The position of the target photosensor unit group corresponds to the position of the echo spot when moving on the target photosensitive pixel.

In some embodiments, when the transmitter emits detection light, echo light reflected by objects of the detection light at different positions is received by the LiDAR. Corresponding to different time of flight of light, positions of the light spot at different time points can be determined in combination with structural parameters (e.g., a focal length of the lens (group)) of the LiDAR based on the time of flight. The second activation circuits can be used to activate multiple photosensor units corresponding to the positions of the light spot at the different time points to form the target photosensor unit group.

For example, in FIG. 7, assuming that a time point of emitting the detection light corresponding to the detection channel is 0, an echo spot reflected of the detection light within a time period of 0-t1 is located in the first region 440-1. The photosensor units in the first region 440-1 are activated as the target photosensor unit group within the time period of 0-t1. An echo spot reflected of the detection light within a time period of t2-t3 is located in the second region 440-2. The photosensor units in the second region 440-2 are activated as the target photosensor unit group within the time period of t2-t3. An echo spot reflected of the detection light within a time period of t4-t5 is located in the third region 440-3. The photosensor units in the third region 440-3 are activated as the target photosensor unit group within the time period of t4-t5. 0<t1. t2<t3. t4<t5.

It should be noted that the activating periods of two adjacent regions can be non-overlapping. Photosensor units in one region are in an activated state at a given time. In this case, t1=t2, and t3=t4. However, the echo spot may move to a junction of two adjacent regions when moving horizontally. The echo spot may cover photosensor units in the two adjacent regions. If one region is activated, the complete optical signal cannot be received. In such a case, the second activation circuit 424-3 can control the two adjacent regions covered by the echo spot to be in the activated state to ensure receiving the complete optical signal. In this case, the activating periods of two adjacent regions can be overlapping. Two regions can be in the activated state at a given time. The target photosensor unit group includes photosensor units in a region within a time period, and can include photosensor units in two regions within another time period. For example, t1>t2, and t3>t4. The “sequentially activate” refers to an order in which different regions are initially activated.

It should be noted that although the target photosensor unit groups in the above embodiments are divided by regions in the target photosensitive pixel, the technical solutions of this disclosure are not limited to this. In some embodiments, some photosensor units can be flexibly selected to form the target photosensor unit group. For example, the time of flight is divided into preset time intervals. The position of the echo spot corresponding to each time interval is determined in combination with the parameters of the LiDAR. Multiple photosensor units covered by the echo spot are used as the target photosensor unit group. As the distance from the object and the time of flight increase, the multiple photosensor units in the target photosensor unit group shift sequentially along the second direction on the target photosensitive pixel. The target photosensor unit groups activated at different time intervals can be at least partially overlapping.

In some embodiments, the sampler further includes a shifter unit. The shifter unit is coupled with the sampling circuit. to the shifter unit can electrically couple the sampling circuit with at least one second activation circuit to form a sampling region. As mentioned above, each photosensor unit can be coupled with a first activation circuit and a second activation circuit. The shifter unit is used to electrically couple the sampling circuit with at least one second activation circuit. The sampling circuit can sample the electrical signal output by the selected second activation circuit to determine the echo signal received by the selected photosensor unit.

In some embodiments, a length of the sampling region in the second direction is less than a length of the target photosensitive pixel in the second direction. The length of the target photosensitive pixel in the second direction can be represented by the number of second activation circuits coupled with the photosensor units of the target photosensitive pixel in the second direction. That is, the sampling region includes a part of the second activation circuits. The sampling circuit is electrically coupled with the second activation circuits coupled with a part of the photosensor units of the target photosensitive pixel at a given time point, instead of sampling the electrical signals output by all the photosensor units. The power consumption of the receiving circuit can be reduced.

In some embodiments, the shifter unit moves the sampling region the second direction in the detection window. The target photosensor unit group moves along the second direction on the target photosensitive pixel. The shifter unit moves the sampling region along the second direction. The echo signal received by the target photosensor unit group can be effectively sampled. Optionally, relative to the target photosensitive pixel and the corresponding multiple second activation circuits, a moving direction of the sampling region is the same as that of the target photosensor unit group.

As shown in FIG. 3, the sampler 422 can include a shifter unit 422-5. The shifter unit 422-5 is coupled with the sampling circuit. The shifter unit 422-5 can couple the sampling circuit with at least one second activation circuit to form a sampling region. The shifter unit 422-5 can further move the sampling region along the second direction in the detection window. The echo signal can be effectively sampled. The power consumption of the receiving circuit can be reduced.

FIG. 8 shows a schematic diagram of coupling between a shifter unit 422-5 and a sampling circuit, provided in some embodiments of this disclosure. As shown in FIG. 8, taking a row of photosensor units as an example, multiple second activation circuits 424-3 are coupled in a one-to-one correspondence with the photosensor units in a row of photosensor units. The sampling circuit 422-11 is coupled multiple second activation circuits 424-3 and can sample electrical signals output by the multiple second activation circuits 424-3. The shifter unit 422-5 is coupled with the sampling circuit 422-11. The shifter unit can control the electrically coupling or decoupling between the sampling circuit and each second activation circuit 424-3.

For example, the shifter unit 422-5 controls one or more second activation circuits 424-3 corresponding to the sampling region to be electrically coupled with the sampling circuit 422-11. In such a case, the sampling circuit 422-11 samples the electrical signals output by the second activation circuits 424-3 in the sampling region.

For example, in FIG. 8, the sampling region includes two second activation circuits 424-3. In a first sampling region 422-51, the sampling circuit 422-11 is electrically coupled with two second activation circuits 424-3 (represented by closed switches in the figure) to sample the output electrical signals. The sampling circuit is not electrically coupled with other second activation circuits 424-3 (represented by open switches in the figure). In this case, the sampling circuit samples echo signals received by a first column of photosensor units and a second column of photosensor units. The sampling region moves along the second direction. In such a case, the shifter unit 422-5 controls the sampling circuit 422-11 to be sequentially electrically coupled with the second activation circuits in the second direction. As shown by a dashed box in FIG. 8, a second sampling region 422-52 corresponds to second activation circuits 424-3 coupled with third and fourth columns of photosensor units. During sampling in the second sampling region 422-52, the shifter unit 422-5 controls the sampling circuit 422-11 to be electrically coupled with the two second activation circuits and not electrically coupled with other second activation circuits. The sampling circuit 422-11 is controlled by the shifter unit 422-5 to be sequentially electrically coupled with every two second activation circuits 424-3 in the second direction (as shown by an arrow in the figure). The sampling region moves along the second direction.

In the technical solutions in the embodiments of this disclosure, the receiver performs mobile sampling. The shifter unit is used to move the sampling region along the second direction to effectively sample the echo signal received by the target photosensor unit group. The echo signal can be received effectively. The power consumption of the receiving circuit can be reduced. Relative to the target photosensitive pixel and the corresponding multiple second activation circuits, a moving direction of the sampling region is the same as that of the target photosensor unit group. When the echo spot moves on the target photosensitive pixel, the sampling region can still completely sample the echo signal without loss of information.

In some embodiments, a moving frequency of the sampling region can be consistent with a sampling frequency of the sampling circuit. The sampling circuit can perform data sampling at a high frequency such as 1 GHz. The moving frequency of the sampling region is consistent with the sampling frequency of the sampling circuit. The moving of the sampling region can be synchronized with the sampling. The interference of the movement of the sampling region on the sampling of the sampling circuit can be reduced, which can ensure the accuracy of electrical signal sampling.

In some embodiments, a moving step length of the sampling region can be less than a length of the sampling region in the second direction, with the sampling region partially overlapping in two adjacent sampling periods. The sampling circuit samples the electrical signal output by the activation circuit at a preset sampling period. Sampling regions partially overlap in the two adjacent sampling periods. The sampling circuit repeatedly samples the electrical signal output by the activation circuit of the overlapped photosensor units. The signal is enhanced, which can improve the detection capability and accuracy of the LiDAR for weak echo signals.

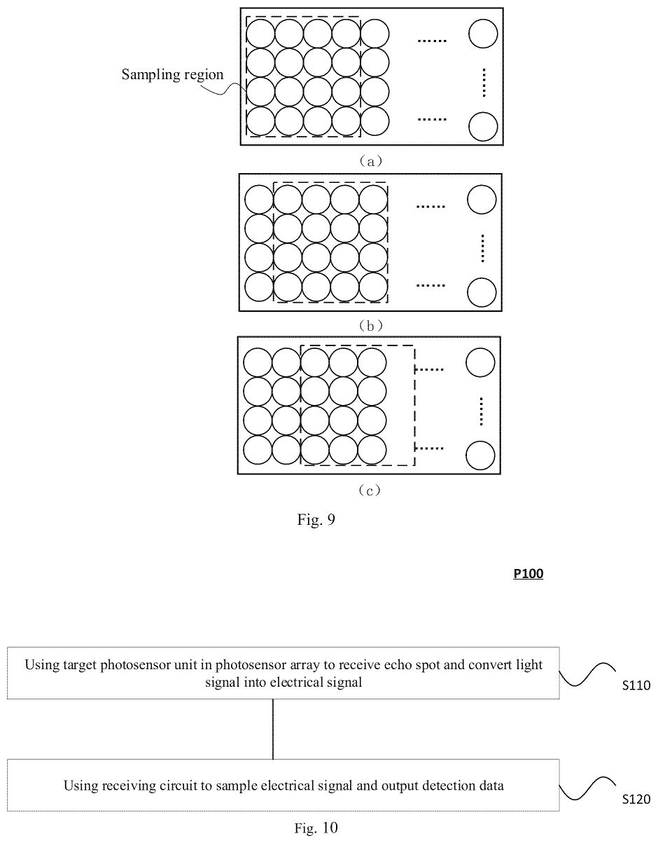

FIG. 9 shows a schematic diagram of moving of a sampling region along a second direction, provided in some embodiments of this disclosure.

As shown in FIG. 9, the sampling region is represented by photosensor units corresponding to activation circuits electrically coupled with a sampling circuit, as shown by a dashed box in the figure. The photosensor units in the sampling region receive an echo optical signal and output an echo electrical signal by a first activation circuit and a second activation circuit. The sampling circuit can sample the echo electrical signal to determine detection data.

FIGS. 9(a) to 9(c) show sampling regions in three sampling periods respectively. As shown in FIG. 9(a), in a first sampling period, the sampling region covers 4×4 photosensor units in the dashed box. As shown in FIG. 9(b), in a second sampling period, the sampling region moves to the right by one photosensor unit. As shown in FIG. 9(c), in a third sampling period, the sampling region moves to the right by another one photosensor unit. In this case, the moving step length is one photosensor unit or one corresponding second activation circuit. Each sampling region is electrically coupled with four second activation circuits in the second direction for sampling. In such a case, the moving step length of the sampling region is less than the length of the sampling region in the second direction. Sampling regions partially overlaps in adjacent sampling periods.

As shown in FIG. 9, sampling regions in the adjacent sampling periods includes three overlapping columns of photosensor units. Signals output by the three columns of photosensor units can be sampled in two sampling periods. Meanwhile, the sampling region in the third sampling period and the sampling region in the first sampling period include two overlapping columns of photosensor units. It can be understood that the sampling region in a fourth sampling period and the sampling region the first sampling period include one overlapping column of photosensor units. In such a case, the sampling circuit will sample data of the fourth column of photosensor units and each subsequent column of photosensor units four times, quadrupling the enhancement of the echo signal received by the photosensor units. The detection capability and accuracy of the LiDAR for weak echo signals can be effectively improved.

It should be noted that the size of the sampling region, the moving step length of the sampling region, and the overlapping part of the sampling regions in the adjacent sampling periods in the above examples are all schematic. Those skilled in the art can set the above parameters in the specific application of the LiDAR, which is not limited in this disclosure.

For example, the frequency at which the photosensor unit and the corresponding activation circuit output the echo electrical signal is low. The sampling frequency of the sampling circuit is much higher than the signal output frequency of the activation circuit. In such a case, it can be understood that an electrical signal output period of the activation circuit is longer than the sampling period of the sampling circuit. The electrical signal output by the activation circuit remains unchanged for a long time. If the sampling circuit samples the electrical signal output by a same activation circuit for multiple times in the electrical signal output period, it can be expected that the electrical signal sampled each time remains unchanged.

In such a case, based on the technical solutions in the embodiments of this disclosure, the sampling regions partially overlap in the two adjacent sampling periods, allowing the sampling circuits to repeated sampling of the echo signal of the photosensor unit in an overlapping region at least twice. The data determined by repeated sampling can be accumulated, which can achieve the effect of data enhancement, and improve the detection accuracy of the LiDAR. And echo light reflected back from an object far away from the LiDAR or with low reflectivity is weak. The above data accumulation can also improve the detection capability of the LiDAR for weak echo signals. The detection capability of distance and objects with low reflectivity of the LiDAR can be improved.

Moreover, the off-axis LiDAR has a blind zone. The echo spot from the blind zone cannot be focused on the photosensor array, but can be focused outside the photosensor array. For an object relatively close to the off-axis LiDAR, even if a reflected echo spot is in the blind zone, a large area of the echo spot can make a part of light to fall on the photosensor array. An optical signal from the part of light is weak and cannot reach a detection threshold, making it easy to be filtered out as noise. In this disclosure, the optical signal from the part of light can be enhanced through the data accumulation to reach the detection threshold. The detection capability of the blind zone of the LiDAR can be improved.

In another aspect, this disclosure provides a method for receiving data of a LiDAR. The method includes using a target photosensitive pixel in a photosensor array to receive an echo spot and converting an optical signal into an electrical signal, and using a receiving circuit to sample the electrical signal and output detection data. The photosensor array includes multiple sub-arrays arranged along a first direction. Each of the multiple sub-arrays includes multiple photosensor units. The receiving circuit includes a sampler. The sampler includes multiple sampling circuit groups corresponding one-to-one with the multiple sub-arrays. A correspondence between the target photosensitive pixel and the sub-array is determined based on a result of calibration. The using the receiving circuit to sample the electrical signal and output detection data includes using a target sampling circuit group to sample the electrical signal output by the target photosensitive pixel and output the detection data.

In the method for receiving data of the LiDAR provided in this disclosure, the correspondence between the target photosensitive pixel and the sub-array is determined based on the result of calibration. The target photosensitive pixel can correspond with one sub-array or two sub-arrays. The correspondence depends on the result of position calibration of the photosensor array. The target photosensitive pixel can correspond with the position of the echo spot of the corresponding detection channel to receive a complete echo optical signal. Then the target sampling circuit group can be used to sample the electrical signal output by the target photosensitive pixel and outputs the detection data. That is, regardless of whether the echo spot is converged on one sub-array or two sub-arrays, the target photosensitive pixel corresponding with the sub-array on which the echo spot is converged can be determined, ensuring that the complete echo spot can be received.

FIG. 10 shows a flowchart of a method P100 for receiving data of a LiDAR, provided in some embodiments of this disclosure. As shown in FIG. 10, the method P100 can include the following steps.

In step 110, a target photosensitive pixel in a photosensor array is used to receive an echo spot convert an optical signal into an electrical signal.

The structure of the photosensor array can refer to the description of the photosensor array 41 and the photosensor array 410.

The target photosensitive pixel can include a sub-array which can receive an echo spot. A correspondence between the target photosensitive pixel and the sub-array can be determined based on a result of calibration. In some examples, the target photosensitive pixels can correspondence one-to-one with the sub-arrays in the photosensor array. Each sub-array can be used as a target photosensitive pixel. There can be other correspondences. For example, a part of a sub-array and a part of an adjacent sub-array form a target photosensitive pixel. The correspondence depends on the result of position calibration of the photosensor array. The target photosensitive pixel can correspond with the position of the echo spot in corresponding detection channel to receive a complete optical signal from the echo spot, and convert the optical signal into an electrical signal.

It can be seen that the target photosensitive pixel corresponds with the distribution of the echo spot on the photosensor array. In such a case, a sub-array or some sub-arrays corresponding to the echo spot can form the target photosensitive pixel to receive a complete echo optical signal. In addition, some sub-arrays that will not be covered by the echo spot, even in the preset corresponding detection channel, are not used to form the target photosensitive pixel, and are not activated to receive the optical signal. The receiving of noise can be reduced, the signal-to-noise ratio of detection can be improved while the integrity of the echo optical signal can be ensured.

In step 120, a receiving circuit is used to sample the electrical signal and output detection data.

The receiving circuit includes a sampler. The sampler includes multiple sampling circuit groups corresponding one-to-one with multiple sub-arrays. The structure of the sampler can refer to the description of the sampler 422. The structure of the sampling circuit group can refer to the description of the sampling circuit group 422-1.

In the embodiments of this disclosure, when an echo spot falls on at least two sub-arrays, the sampler can sample electrical signals of the at least two sub-arrays using a sampling circuit group.

In an embodiment, the receiving circuit can use a target sampling circuit group to sample the electrical signal output by the target photosensitive pixel and output the detection data. Regardless of whether the echo spot is converged on one sub-array or multiple sub-arrays, a complete electrical signal from the echo spot can be sampled using the target sampling circuit group corresponding to one sub-array. The low power consumption of the LiDAR can be maintained, while the integrity of the echo signal can be ensured. The conflict between low power consumption of the LiDAR can be solved and integrity of optical signal when alignment between an emitting end and a receiving end deviates.

In some embodiments, the receiving circuit further includes an activation module coupled with the photosensor array. The activation module can include first activation circuits corresponding one-to-one with the photosensor units in the first direction and second activation circuits corresponding one-to-one with the photosensor units in the second direction. The structure of the activation module can refer to the description of the activation module 424.

The receiving circuit can use the activation module to activate the target photosensitive pixel to output the electrical signal. For example, the receiving circuit can independently activate each photosensor unit in the target photosensitive pixel using the first activation circuits and the second activation circuits of the activation module. The target photosensitive pixel can output the electrical signal. That is, the multiple photosensor units can be activated by first activation circuits and second activation circuits to form the target photosensitive pixel. The target photosensitive pixel corresponds with the distribution of the echo spot on the photosensor array, which can increase the signal-to-noise ratio of detection of the LiDAR.

In some embodiments, each sampling circuit group includes multiple sampling circuits. The multiple sampling circuits can be coupled one-to-one with the first activation circuits of the sub-array. The multiple sampling circuits can also be coupled one-to-one with first activation circuits of an adjacent sub-array. That is, each sampling circuit can be coupled with first activation circuits of at least two adjacent sub-arrays. Each sampling circuit group can sample electrical signals of at least two sub-arrays. In some embodiments, each sampling circuit in a sampling circuit group can sample an electrical signal from a sub-array corresponding to the sampling circuit group or an electrical signal from an adjacent sub-array.

When the target photosensitive pixel includes photosensor units in multiple sub-arrays, the receiving circuit can sample the electrical signal output by the target photosensitive pixel using the target sampling circuit group corresponding with one of the multiple sub-arrays. At least one sampling circuit in the target sampling circuit group samples the electrical signal output by photosensor unit of the target photosensitive pixel in the adjacent sub-array.

In the embodiments of this disclosure, each sampling circuit can sample electrical signals from two adjacent sub-arrays. Even if the echo spot falls on two adjacent sub-arrays or a sub-array corresponding to another detection channel, the complete electrical signal of the echo spot can be sampled using the sampling circuits in a sampling circuit group.

In some embodiments, the receiving circuit can use at least one selector to couple the target sampling circuit group with the first activation circuits of the target photosensitive pixel. Each sampling circuit in the target sampling circuit group is coupled with the first activation circuits of two sub-arrays by a selector.

In an embodiment, each sampling circuit can be coupled with two first activation circuits of two adjacent sub-arrays by a selector. Or each sampling circuit can be coupled with two groups of first activation circuits of two adjacent sub-arrays by a selector. Each selector can control a corresponding sampling circuit to be electrically coupled with a first activation circuit or a group of first activation circuits. It can be understood that each sampling circuit is coupled with two or more first activation circuits or two or more groups of first activation circuits with a data flow mapping relationship. Each sampling circuit can be electrically coupled with one first activation circuit or one group of first activation circuits by the selector. When detecting, each sampling circuit samples or receives electrical signals from one or one group of first activation circuits.

For example, when a detection channel is detecting, each of multiple sampling circuits in the sampling circuit group corresponding to the detection channel is coupled with at least two or two groups of first activation circuits. The photosensor units corresponding with the at least two first activation circuits or two groups of first activation circuits do not simultaneously receive the echo signal in the detection channel. For example, photosensor units corresponding to a first activation circuit or a group of first activation circuits can receive the echo signal. Photosensor units corresponding to other first activation circuits are not covered by the echo spot. The sampling circuit is controlled by the selector to be electrically coupled with a first activation circuit or a group of first activation circuits. Targeted sampling can be performed on the echo signal to reduce the sampling of invalid signals, which can improve the efficiency of the receiving circuit, and reduce the power consumption.

In an embodiment, sampling circuits correspond one-to-one with selectors. Each sampling circuit is coupled with at least a first activation circuit of the corresponding sub-array and a first activation circuit of the adjacent sub-array. Selectors corresponding one-to-one with the sampling circuits can control each sampler circuit to be electrically coupled with which one first activation circuit or group of first activation circuits to sample electrical signals output by the first activation circuits.

In some embodiments, the receiving circuit can use the second activation circuit to sequentially activate photosensor units in a detection window in different regions to form a target photosensor unit group. The position of the target photosensor unit group corresponds to the distribution of the echo spot on the target photosensitive pixel.

The detection window refers to a time window during which the target photosensitive pixel of a detection channel begins to be activated to receive the echo signal and the detection of the detection channel ends. The echo spot moves along the second direction of the target photosensitive pixel in the detection window. Through the position of the target photosensor unit group corresponding to the distribution of the echo spot on the target photosensitive pixel, the target photosensor unit group corresponding to the echo spot can receive the echo signal. Photosensor units not covered by the echo spot can be in a non-activated or non-gated state. The power consumption of the LiDAR can be reduced while the receiving of too many interference signals such as ambient light can be avoided. The signal-to-noise ratio of detection can be improved.

For example, the second direction is consistent with the relative positions of the transmitter and the receiver. When the transmitter and the receiver are relatively arranged in the horizontal direction, the second direction is the horizontal direction.

In some embodiments, the receiving circuit can further use a shifter unit couple the target sampling circuit group with at least one second activation circuit to form a sampling region. The receiving circuit can control the shifter unit to move the sampling region along the second direction in the detection window. The target sampling circuit group samples the electrical signal output by the target photosensitive pixel in moving sampling region. A size, a moving frequency, and a moving step length of the sampling region can refer to the relevant descriptions.

In the embodiments of this disclosure, the receiver performs mobile sampling. The shifter unit is used to move the sampling region along the second direction to effectively sample the echo signal received by the target photosensor unit group. The echo signal can be effectively received. The power consumption of the receiving circuit can be reduced. Relative to the target photosensitive pixel and corresponding multiple second activation circuits, a moving direction of the sampling region is the same as that of the target photosensor unit group. When the echo spot moves on the target photosensitive pixel, the sampling region can still completely sample the echo signal without loss of information.

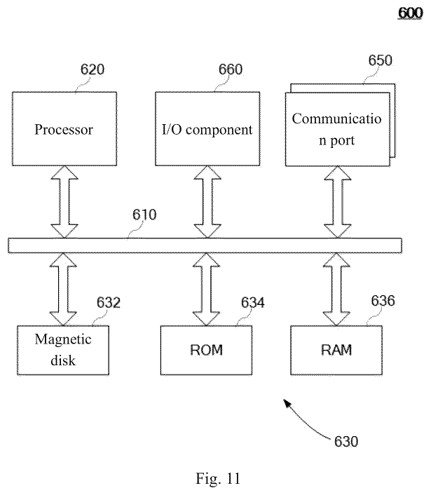

In another aspect, FIG. 11 shows a hardware structure diagram of a controller 600, provided in some embodiments of this disclosure. The controller 600 can be a system for receiving data. The controller 600 can execute the method P100 for receiving data described in this disclosure. When the method P100 for receiving data is executed in a server, the controller 600 can be the server.

As shown in FIG. 11, the controller 600 can include at least one storage medium 630 and at least one processor 620. Based on some embodiments of this disclosure, the controller 600 can further include a communication port 650 and an internal communication bus 610. Meanwhile, the controller 600 can further include an I/O component 660.

The internal communication bus 610 can connect different system components, including the storage medium 630, the processor 620, and the communication port 650.

The I/O component 660 supports input/output between the controller 600 and other components.

The communication port 650 can control data communication between the controller 600 and the outside. For example, the communication port 650 can be used to control data communication between the controller 600 and a network 400. The communication port 650 can be a wired communication port or a wireless communication port.

At least one processor 620 can be in communication connection with at least one storage medium 630 and a communication port 650 by an internal communication bus 610. The at least one processor 620 can execute the at least one instruction set mentioned above. When the controller 600 operates, the at least one processor 620 reads the at least one instruction set and executes the method P100 for receiving data provided in this disclosure based on instructions of the at least one instruction set. The processor 620 can execute all steps included in the method P100 for receiving data. The processor 620 can be in the form of one or more processors. Based on some embodiments of this disclosure, the processor 620 can include one or more hardware processors, such as a microcontroller, a microprocessor, a reduced instruction set computer (“RISC”), an application specific integrated circuit (“ASIC”), an application specific instruction set processor (“ASIP”), a central processing unit (“CPU”), a graphics processing unit (“GPU”), a physical processing unit (“PPU”), a microcontroller unit, a digital signal processor (“DSP”), a field programmable gate array (“FPGA”), an advanced RISC machine (“ARM”), a programmable logic device (“PLD”), any circuit or processor capable of executing one or more functions, or any combination thereof. For illustrative purposes, one processor 620 is described in the controller 600 in this disclosure. However, it should be noted that the controller 600 in this disclosure can further include multiple processors. In such a case, the operations and/or method steps disclosed in this disclosure can be executed by one processor as described in this disclosure, or can be jointly executed by multiple processors. For example, if the processor 620 of the controller 600 executes step A and step B in this disclosure, it should be understood that step A and step B can also be jointly or separately executed by two different processors 620 (e.g., a first processor executes step A, a second processor executes step B, or the first and second processors jointly execute steps A and B).

The storage medium 630 can include a data storage device. The data storage device can be a non-transitory storage medium. For example, the data storage device can include one or more of a magnetic disk 632, a read-only memory (“ROM”) 634, or a random access memory (“RAM”) 636.

In another aspect, this disclosure provides a non-transitory computer-readable medium storing at least one instruction set for receiving data. When the at least one instruction set is executed by a processor, the processor is instructed to execute the steps of the method P100 for receiving data in this disclosure. In some possible embodiments, various aspects of this disclosure can also be implemented in the form of a program product including program codes. When the program product runs on the controller 600, the program codes are configured to enable the controller 600 to execute the steps of the method P100 for receiving data described in this disclosure. The program product used to implement the above method can be a portable compact disc read-only memory (“CD-ROM”) that includes program codes and can run on the controller 600. However, the program product in this disclosure is not limited to this. In this disclosure, the readable storage medium can be any tangible medium containing or storing a program that can be used by or in combination with an instruction execution system. The program product can be any combination of one or more readable media. The readable medium can be a readable signal medium or a readable storage medium. The readable storage medium can be, for example, but not limited to, electric, magnetic, optical, electromagnetic, infrared, or semiconductor systems, apparatuses, or devices, or any combination thereof. A more detailed example of the readable storage medium includes an electrical connection with one or more leads, a portable disk, a hard disk, a random access memory (“RAM”), a read-only memory (“ROM”), an erasable programmable read-only memory (“EPROM” or a flash memory), a fiber optic, a portable compact disc read-only memory (“CD-ROM”), an optical storage device, a magnetic storage device, or any suitable combination thereof. The computer-readable storage medium can include a data signal propagated in a baseband or as a part of a carrier, the data signal carrying a readable program code. The propagated data signal can be in various forms, including but not limited to an electromagnetic signal, an optical signal, or any suitable combination thereof. The readable storage medium can also be any readable medium other than the readable storage medium. The readable medium can send, propagate, or transmit a program used by or in combination with an instruction execution system, apparatus, or device. The program code contained in the readable storage medium can be transmitted by any suitable medium, including but not limited to a wireless medium, a wired medium, a fiber optic cable, a radio frequency (“RF”), or any suitable combination thereof. The program code for performing the operation in this disclosure can be written in any combination of one or more programming languages. The programming languages include object-oriented programming languages such as Java and C++, and further include conventional procedural programming languages such as “C” language or similar programming languages. The program code can be completely executed on the controller 600, partially executed on the controller 600, executed as an independent software package, partially executed on the controller 600 and partially executed on a remote controller, or completely executed on the remote controller.

The detailed embodiments of this disclosure are described above. Other embodiments are within the scope of the appended claims. In some cases, the actions or steps described in the claims can be performed in a different order than in the embodiments and can still achieve desired results. Additionally, the processes depicted in the drawings are not necessarily required to be shown in a specific or continuous order to achieve desired results. In some embodiments, multitasking and parallel processing are also possible or may be advantageous.

In summary, after reading this detailed disclosure, those skilled in the art can understand that the foregoing detailed disclosure can be presented by way of example only and may not be limiting. Although not explicitly stated herein, it can be understood by those skilled in the art that the requirements of this disclosure encompass various reasonable changes, improvements, and modifications to embodiments. These changes, improvements, and modifications are intended to be proposed in this disclosure and are within the spirit and scope of exemplary embodiments of this disclosure.

In addition, certain terms in this disclosure have been used to describe embodiments of this disclosure. For example, at least one of “one embodiment,” “embodiments,” or “some embodiments” means that specific features, structures, or characteristics described in conjunction with the embodiments can be included in at least one embodiment of this disclosure. Accordingly, it can be emphasized and understood that two or more references to “embodiments,” “one embodiment,” or “alternative embodiments” in various parts of this disclosure do not necessarily refer to the same embodiment. In addition, specific features, structures, or characteristics can be appropriately combined in one or more embodiments of this disclosure.

It should be understood that in the foregoing description of embodiments of this disclosure, to assist in understanding one feature and for the purpose of simplifying this disclosure, various features in this disclosure are combined in a single embodiment, drawings, or description thereof. However, this does not mean that the combination of these features is necessary. It is entirely possible for those skilled in the art to label some of the devices as separate embodiments for understanding when reading this disclosure. That is to say, embodiments in this disclosure can also be understood as integration of multiple secondary embodiments. The content of each secondary embodiment is also valid when it is less than all features of a single previously disclosed embodiment.

Each patent, patent application, publication of the patent application, and other materials cited herein, such as articles, books, specifications, publications, documents, and items, can be incorporated herein by reference. All content is intended for all purposes, except for any related prosecution document history that may be any same prosecution document history inconsistent or conflicting with this document, or any same prosecution document history with a limiting effect on the broadest scope of the claims. This document is associated now or later. For example, if there is any inconsistency or conflict between at least one of description, definition, or use of terms associated with any of the materials included and at least one of terms, description, definition, or use related to this document, the terms in this document are used as standard.

Finally, it should be understood that embodiments of this disclosure illustrate the principles of the embodiments of this disclosure. Other modified embodiments are also within the scope of this disclosure. Accordingly, the embodiments of this disclosure are merely examples and not limitations. Those skilled in the art can use alternative configurations based on the embodiments in this disclosure to implement this disclosure. Accordingly, the embodiments of this disclosure are not limited to the embodiments precisely described in the disclosure.

1. A receiver for a LiDAR, comprising:
a photosensor array configured to receive an echo spot and convert an optical signal into an electrical signal, and
a receiving circuit coupled with the photosensor array and configured to sample the electrical signal and output detection data,
wherein the photosensor array comprises a plurality of sub-arrays arranged along a first direction, and each of the plurality of sub-arrays comprises a plurality of photosensor units;
wherein the receiving circuit comprises a sampler comprising a plurality of sampling circuit groups corresponding to the plurality of sub-arrays; and
wherein when the echo spot falls on at least two sub-arrays, the sampler is configured to sample electrical signals from the at least two sub-arrays by utilizing a sampling circuit group.

2. The receiver of claim 1, wherein the receiving circuit further comprises a plurality of activation circuits coupled with the photosensor array, and the plurality of activation circuits are configured to activate a target photosensitive pixel to receive the echo spot and output the electrical signal.

3. The receiver of claim 2,
wherein a target activation circuit is configured to activate the target photosensitive pixel, with the target photosensitive pixel corresponding to a distribution of the echo spot on the photosensor array, and
wherein a target sampling circuit group is coupled with the target activation circuit and is configured to sample the electrical signal output by the target photosensitive pixel.

4. The receiver of claim 1,
wherein:
each of the plurality of sub-arrays comprises a plurality of photosensor units arranged along the first direction and a second direction perpendicular to the first direction,
the receiving circuit further comprises a plurality of first activation circuits and a plurality of second activation circuits,
the plurality of first activation circuits are corresponding one-to-one with photosensor units in the first direction, and
the plurality of second activation circuits are corresponding one-to-one with photosensor units in the second direction, and
wherein the plurality of first activation circuits and the plurality of second activation circuits are configured to independently activate each of the plurality of photosensor units.

5. The receiver of claim 4,
wherein each of the plurality of the sampling circuit groups comprises a plurality of sampling circuits coupled one-to-one with first activation circuits of a sub-array, and
wherein the plurality of sampling circuits are coupled one-to-one with first activation circuits of an adjacent sub-array.

6. The receiver of claim 5, wherein the sampler further comprises at least one selector, and each of the plurality of sampling circuits is coupled with a first activation circuit of corresponding sub-array and a first activation circuit of the adjacent sub-array by a selector, and
wherein each selector is configured to control a corresponding sampling circuit to be electrically coupled with one first activation circuit.

7. The receiver of claim 4, wherein the plurality of the second activation circuits are configured to sequentially activate photosensor units in different regions in a detection window to form a target photosensor unit group, with a position of the target photosensor unit group corresponding to a distribution of the echo spot on a target photosensitive pixel.

8. The receiver of claim 7, wherein:
the sampler further comprises a shifter unit coupled with a sampling circuit and configured to couple the sampling circuit with at least one second activation circuit to form a sampling region, and
the shifter unit is configured to move the sampling region along the second direction in the detection window.

9. The receiver of claim 8, wherein a moving frequency of the sampling region is consistent with a sampling frequency of the sampling circuit.

10. The receiver of claim 8, wherein a moving step length of the sampling region is less than a length of the sampling region in the second direction, with the sampling region partially overlapping in two adjacent sampling periods.

11. A method for receiving data of a LiDAR, comprising:
utilizing a target photosensitive pixel in a photosensor array to receive an echo spot and convert an optical signal into an electrical signal, and
utilizing a receiving circuit to sample the electrical signal and output detection data,
wherein the photosensor array comprises a plurality of sub-arrays arranged along a first direction, each of the plurality of sub-arrays comprises a plurality of photosensor units, the receiving circuit comprises a sampler, the sampler comprises a plurality of sampling circuit groups corresponding one-to-one with the plurality of sub-arrays,
wherein a correspondence between the target photosensitive pixel and a sub-array is determined based on a result of calibration, and
wherein utilizing the receiving circuit to sample the electrical signal and output detection data comprises:
utilizing a target sampling circuit group to sample the electrical signal output by the target photosensitive pixel and output the detection data.

12. The method of claim 11, wherein the receiving circuit further comprises a plurality of activation circuits coupled with the photosensor array, and
wherein utilizing the receiving circuit to sample the electrical signal and output detection data further comprises:
utilizing the plurality of activation circuits to activate the target photosensitive pixel to output the electrical signal.

13. The method of claim 12,
wherein utilizing the plurality of the activation circuits to activate the target photosensitive pixel comprises:
utilizing a plurality of first activation circuits and a plurality of second activation circuits to independently activate each photosensor unit in the target photosensitive pixel, and
wherein each of the plurality of sub-arrays comprises a plurality of photosensor units arranged along the first direction and a second direction perpendicular to the first direction, the plurality of first activation circuits correspond to photosensor units in the first direction, and the plurality of second activation circuits correspond to photosensor units in the second direction.

14. The method of claim 13,
wherein each of the plurality of the sampling circuit groups comprises a plurality of sampling circuits corresponding one-to-one with first activation circuits of a sub-array, and the plurality of sampling circuits are coupled one-to-one with first activation circuits of an adjacent sub-array, and
wherein, when the target photosensitive pixel comprises photosensor units in a plurality of sub-arrays, utilizing the target sampling circuit group to sample the electrical signal output by the target photosensitive pixel comprises:
utilizing a target sampling circuit group corresponding to one of the plurality of the sub-arrays to sample the electrical signal output by the target photosensitive pixel, and
wherein at least one sampling circuit in the target sampling circuit group is configured to sample an electrical signal output by a photosensor unit of the target photosensitive pixel in the adjacent sub-array.

15. The method of claim 14, further comprising:
utilizing at least one selector to electrically couple the target sampling circuit group with the plurality of the first activation circuits of the target photosensitive pixel, wherein each sampling circuit in the target sampling circuit group is coupled with the plurality of the first activation circuits of two sub-arrays by a selector.

16. The method of claim 14, wherein utilizing the plurality of the activation circuits to activate the target photosensitive pixel comprises:
utilizing the plurality of the second activation circuits to sequentially activate photosensor units in different regions in a detection window to form a target photosensor unit group, with a position of the target photosensor unit group corresponding to a distribution of the echo spot on the target photosensitive pixel.

17. The method of claim 16, wherein utilizing the target sampling circuit group to sample the electrical signal output by the target photosensitive pixel comprises:
utilizing a shifter unit to couple the target sampling circuit group with at least one second activation circuit to form a sampling region, and
controlling the shifter unit to move the sampling region along the second direction in the detection window, and controlling the target sampling circuit group to sample the electrical signal output by the target photosensitive pixel in moving sampling region.

18. A LiDAR, comprising:
at least one storage medium storing at least one instruction set for receiving data; and
at least one processor in communication connection with the at least one storage medium,
wherein when the LiDAR operates, the at least one processor is configured to read the at least one instruction set and implement a method for receiving data, and wherein the method comprising:
utilizing a target photosensitive pixel in a photosensor array to receive an echo spot and convert an optical signal into an electrical signal, and
utilizing a receiving circuit to sample the electrical signal and output detection data,
wherein the photosensor array comprises a plurality of sub-arrays arranged along a first direction, each of the plurality of sub-arrays comprises a plurality of photosensor units, the receiving circuit comprises a sampler, and the sampler comprises a plurality of sampling circuit groups corresponding one-to-one with the plurality of sub-arrays,
wherein a correspondence between the target photosensitive pixel and a sub-array is determined based on a result of calibration, and
wherein utilizing the receiving circuit to sample the electrical signal and output detection data comprises:
utilizing a target sampling circuit group to sample the electrical signal output by the target photosensitive pixel and output the detection data.

19. A non-transitory computer-readable medium, storing at least one instruction set for receiving data, wherein when the at least one instruction set is executed by a processor, the processor is instructed to execute a method for receiving data, and wherein the method comprising:
utilizing a target photosensitive pixel in a photosensor array to receive an echo spot and convert an optical signal into an electrical signal, and
utilizing a receiving circuit to sample the electrical signal and output detection data,
wherein the photosensor array comprises a plurality of sub-arrays arranged along a first direction, each of the plurality of sub-arrays comprises a plurality of photosensor units, the receiving circuit comprises a sampler, and the sampler comprises a plurality of sampling circuit groups corresponding one-to-one with the plurality of sub-arrays,
wherein a correspondence between the target photosensitive pixel and a sub-array is determined based on a result of calibration, and
wherein utilizing the receiving circuit to sample the electrical signal and output detection data comprises:
utilizing a target sampling circuit group to sample the electrical signal output by the target photosensitive pixel and output the detection data.
